(19) United States
(12) Patent Application Publication
(10) Pub. No.: US 2015/0084757 A1
(43) Pub. Date: Mar. 26, 2015

(54) METHODS AND SYSTEMS FOR DETERMINING AUTO ACCIDENTS USING MOBILE PHONES AND INITIATING EMERGENCY RESPONSE

(71) Applicant: Agero, Inc., Medford, MA (US)

(72) Inventors: Christopher Annibale, Malden, MA (US); Raj Behara, Andover, MA (US); Julian J. Bourne, Weston, MA (US); David P. Ferrick, Lexington, MA (US); Joseph McDonald, Rockport, MA (US)

(21) Appl. No.: 14/493,040

(22) Filed: Sep. 22, 2014

Related U.S. Application Data
(60) Provisional application No. 61/881,122, filed on Sep. 23, 2013.

(51) Int. Cl. G08B 25/10

(52) U.S. Cl. CPC G08B 25/10
USPC 340/436

(57) ABSTRACT

A method for providing automatic crash management (ACM) is provided. An ACM application is enabled on a mobile device. Data is collected from a plurality of sensors associated with the mobile device. The data from the plurality of sensors is processed with the ACM application. The processed data is monitored with accident logic of the ACM application running on the mobile device to determine whether a crash has been detected. The data from the plurality of sensors is automatically streamed to the off-board server for further analysis upon detection of the crash.

### CROSS-REFERENCE TO RELATED APPLICATIONS

This application claims priority to U.S. Provisional Application Ser. No. 61/881,122, filed on Sep. 23, 2013), the entire disclosure of which is hereby incorporated herein by reference in its entirety.

### STATEMENT REGARDING FEDERALLY SPONSORED RESEARCH OR DEVELOPMENT

Not Applicable

### FIELD OF THE INVENTION

The present invention lies in the field of emergency driver services and response to automobiles. The present disclosure relates to methods and systems for determining an occurrence of an auto accident using a mobile phone and for initiating an emergency response.

### BACKGROUND OF THE INVENTION

Since the 1967 Congressional mandate, 911 has become the universal number in the United States to contact emergency services. Currently, approximately 240 million calls are made to 911 annually. On a national basis, approximately one-third are wireless. Yet, in many communities, the ratio is fifty percent (50%) or more according to the National Emergency Number Association.

Mobile phones have transformed a driver's ability to reach emergency services. Yet the reporting of auto accidents to emergency services is a complex problem for a few reasons. First, the driver can be incapacitated. Another reason is what is referred to as the “bystander effect”—a social psychological phenomenon that refers to cases in which individuals do not offer any means of help to a victim when other people are present. Under this theory, the probability of help is inversely related to the number of bystanders. In other words, the greater the number of bystanders, the less likely it is that any one of them will help. Several variables help to explain why the bystander effect occurs. These variables include: ambiguity, cohesiveness, and diffusion of responsibility. A third reason is due to inaccurate bystander reporting. All of these situations lead to delays in emergency services, which significantly reduce survivability in severe accidents and increase injury impact. FIG. 1 is a graph indicating the potential harm caused by delays in responding.

Currently, of the over 5 million vehicle accidents per year, over 30,000 involve a fatality and over 2.2 million involve injury.

There have been significant advances in the past twenty years in emergency response to auto accidents from the advancement of the rules of triage, better emergency services training, and advances in vehicle safety. FIG. 2 illustrates improvement in response time due to the use of automatic collision notification (ACN). Those vehicles with on-board telematics have implemented ACN to assist drivers that are in an accident but the vehicles and/or passengers are unable to call for help. While ACN is a life-saving technology that is a significant step forward in protecting drivers, the availability is limited to a subset of newer vehicles. Such automotive hardware safety innovations take decades to reach significant levels of adoption in all vehicles.

Thus, a need exists to overcome the problems with the prior art systems, designs, and processes as discussed above.

### SUMMARY OF THE INVENTION

The invention provides methods and systems for determining an occurrence of an auto accident, e.g., a crash, using a mobile phone and for initiating an emergency response that overcome the hereinafore-mentioned disadvantages of the heretofore-known devices and methods of this general type and that provide Automatic Crash Notification from a smartphone. These methods and systems solve the problems presented by driver accident incapacitation, the bystander effect, inaccurate 911 reports, and the limitations of vehicle-based ACN. Smartphones are capable of advanced signal processing using multiple location and motion based sensors onboard. This, combined with the personal nature of the device, makes it an ideal platform for detecting accident severity and potential injury and for notifying emergency services.

With the foregoing and other objects in view, there is provided, in accordance with the invention, a method for providing automatic crash management (ACM). An ACM application is enabled on a mobile device. Data is collected from a plurality of sensors associated with the mobile device. The data from the plurality of sensors is processed with the ACM application. The processed data is monitored with accident detection logic of the ACM application running on the mobile device to determine whether a crash has been detected. A severity of the crash is determined from the processed data with the ACM application. The determined severity is sent to an off-board server. The data from the plurality of sensors is automatically streamed to the off-board server for further analysis upon detection of the crash.

With the objects of the invention in view, there is also provided in accordance with the invention, a method for providing automatic crash management (ACM). An ACM application is enabled on a mobile device. Data is collected from a plurality of sensors associated with the mobile device. The data from the plurality of sensors is processed with the ACM application. The processed data is monitored with accident detection logic of the ACM application running on the mobile device to determine whether a crash has been detected. The data from the plurality of sensors is automatically streamed to the off-board server for further analysis upon detection of the crash.

In accordance with another mode of the invention, the plurality of sensors are located in the mobile device.

In accordance with a further mode of the invention, the plurality of sensors are located in one or more wearable computing devices in addition to the sensors located in the mobile device.

In accordance with an added mode of the invention, the wearable computing devices are synced with the mobile device.

In accordance with an additional mode of the invention, the wearable devices connect with a cellular and/or WIFI network.

In accordance with yet another mode of the invention, the ACM application confirms the crash using data from the plurality of sensors of the mobile device and/or wearable computing device.

In accordance with yet a further mode of the invention, crash detection is performed as a Bayesian inference algorithm incorporating a motion signature of the mobile device.

In accordance with yet an added mode of the invention, the processed data is recorded for a specified time before and after a detected crash.

In accordance with yet an additional mode of the invention, an ambient light sensor of the mobile device is used by the ACM application to determine a relative position of the mobile device.

In accordance with again another mode of the invention, a flash function of the mobile device is used by the ACM application to take pictures and/or record video prior to, during, and after the crash.

In accordance with again a further mode of the invention, the ACM application determines status data of a crash victim with the plurality of sensors.

In accordance with again an added mode of the invention, the status data includes biometric information.

In accordance with still another mode of the invention, the severity of the crash is based on an inferred delta velocity and a road type.

In accordance with still a further mode of the invention, biometric data in addition to other sensor data of the plurality of sensors is used to determine severity.

In accordance with still an added mode of the invention, the ACM application alerts a user of the mobile device that a crash has been detected.

In accordance with still an additional mode of the invention, the ACM application provides a user of the mobile device with an option to cancel assistance.

In accordance with a further mode of the invention, the ACM application initiates the automatic streaming of the data from the plurality of sensors and continues to determine severity and monitor for other events with the mobile device.

In accordance with another mode of the invention, the ACM application acts as a mobile event data recorder that retrospectively records event information.

In accordance with a concomitant feature of the invention, the data from the plurality of sensors is processed one of periodically and continuously depending on the resources available to the mobile device.

Although the invention is illustrated and described herein as embodied in methods and systems for determining an occurrence of an auto accident using a mobile phone and for initiating an emergency response, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a graph depicting accident response times before implementation of automatic crash notifications;

FIG. 2 is a graph depicting a decrease in accident response time after automatic crash notifications started being implemented;

FIG. 3 is a diagrammatic illustration of a mobile device display providing crash acceleration data before, during and after an accident has occurred;

FIG. 4 is a diagrammatic illustration of a mobile device display providing a notification to confirm an accident occurred;

FIG. 5 is a flow chart of benefits provided by the systems and methods for resolving insurance claims after an accident occurs;

FIG. 6 illustrates a block diagram of a method for determining a severity of an accident in accordance with one embodiment;

FIG. 7 illustrates a block diagram of a method for setting up ACM monitoring in accordance with one embodiment;

FIG. 8 illustrates a block diagram of a method for monitoring events of interest in accordance with one embodiment; and

FIG. 9 illustrates a block diagram of a method for providing off-board processing of an event in accordance with one embodiment.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

It will be appreciated that embodiments of the invention described herein may be comprised of one or more conventional processors and unique stored program instructions that control the one or more processors to implement, in conjunction with certain non-processor circuits and other elements, some, most, or all of the functions of the powered injector devices described herein. The non-processor circuits may include, but are not limited to, signal drivers, clock circuits, power source circuits, and user input and output elements. Alternatively, some or all functions could be implemented by a state machine that has no stored program instructions, or in one or more application specific integrated circuits (ASICs) or field-programmable gate arrays (FPGA), in which each function or some combinations of certain of the functions are implemented as custom logic. Of course, a combination of these approaches could also be used. Thus, methods and means for these functions have been described herein.

The terms “program,” “software,” “software application,” and the like as used herein, are defined as a sequence of instructions designed for execution on a computer system. A “program,” “software,” “application,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

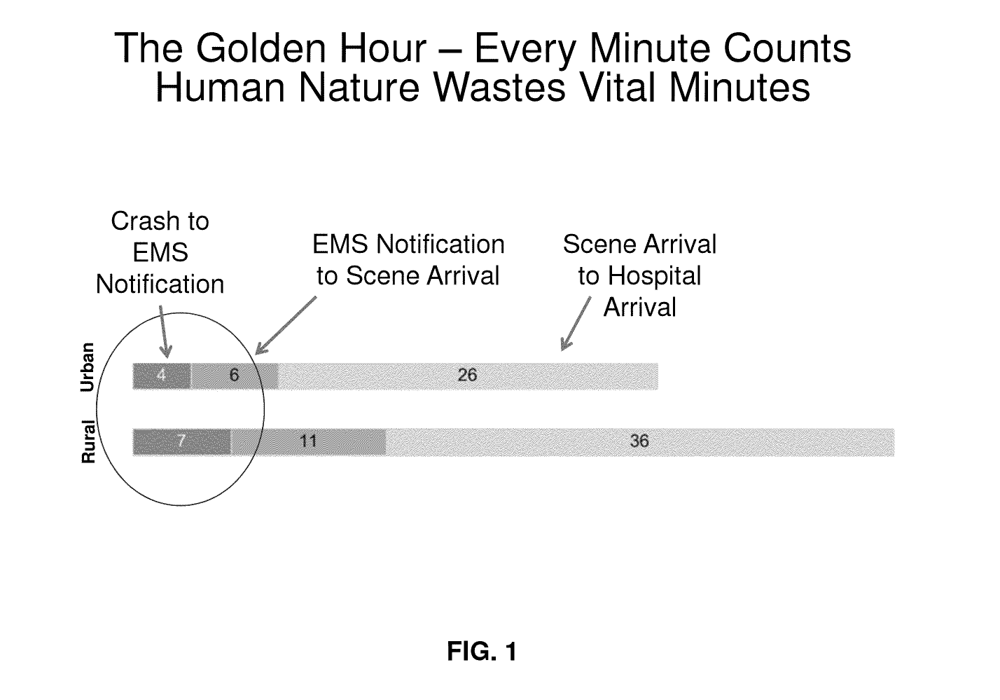

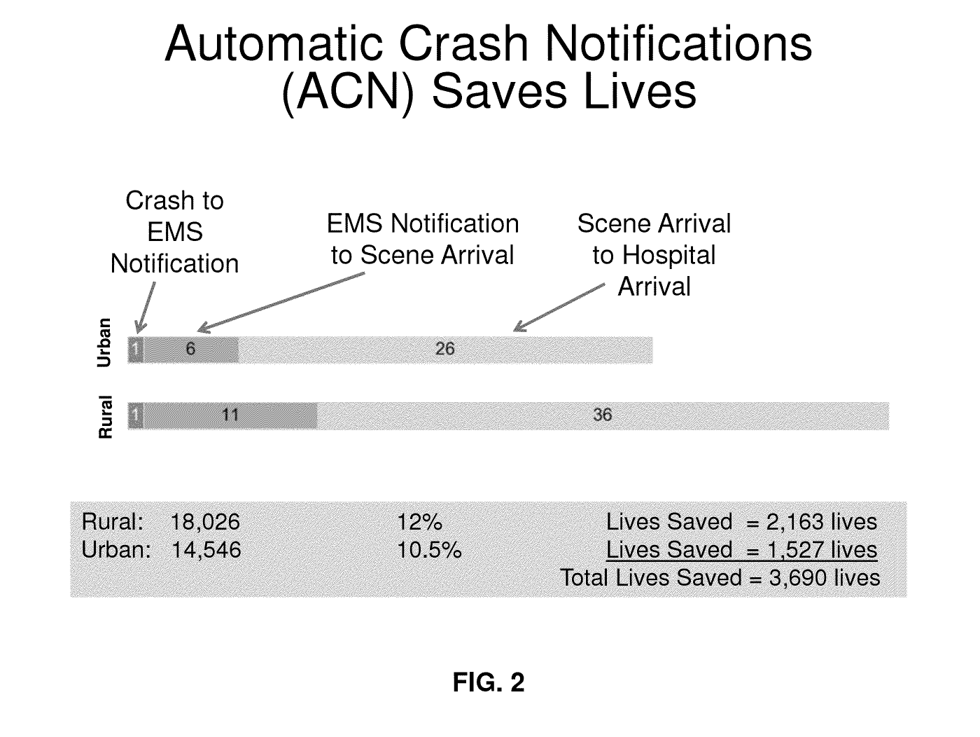

Described now are exemplary embodiments of the present invention. Referring now to the figures of the drawings in detail and first, particularly to FIG. 1, there is shown a first exemplary embodiment of a method and system for determining an occurrence of an auto accident using a mobile device, e.g., a mobile phone, and for initiating an emergency response. The system, which operates as a mobile application, has four components: three dimensional acceleration visualization; accident detection logic; emergency contact center notification; and emergency services dispatching. The application can operate in the background, in which it is functioning but is not observable to the user. Alternatively the application can operate in the foreground, where the application is observable by the user. The present disclosure describes various aspects of automatic crash management (ACM) of which ACN can be a component.

In one embodiment, the mobile device collects data from various sensors. This data can be packetized and sent to an off-board, e.g., backend, system/server for data storage and/or analysis. The off-board system/server can be implemented in a physical server, a virtual server, and/or a cloud-based server system.

In one embodiment, the ACM system uses data from wearable computing devices either alone and/or in addition to data collected from a mobile device of the user. The wearable devices are synced/connected/paired to the mobile device. Data collected from wearable devices using the mobile device can be collected from the wearable device using any applicable short-range wireless network protocol. In one embodiment, the wearable devices include all applicable sensors and connect directly with the off-board or backend system/server.

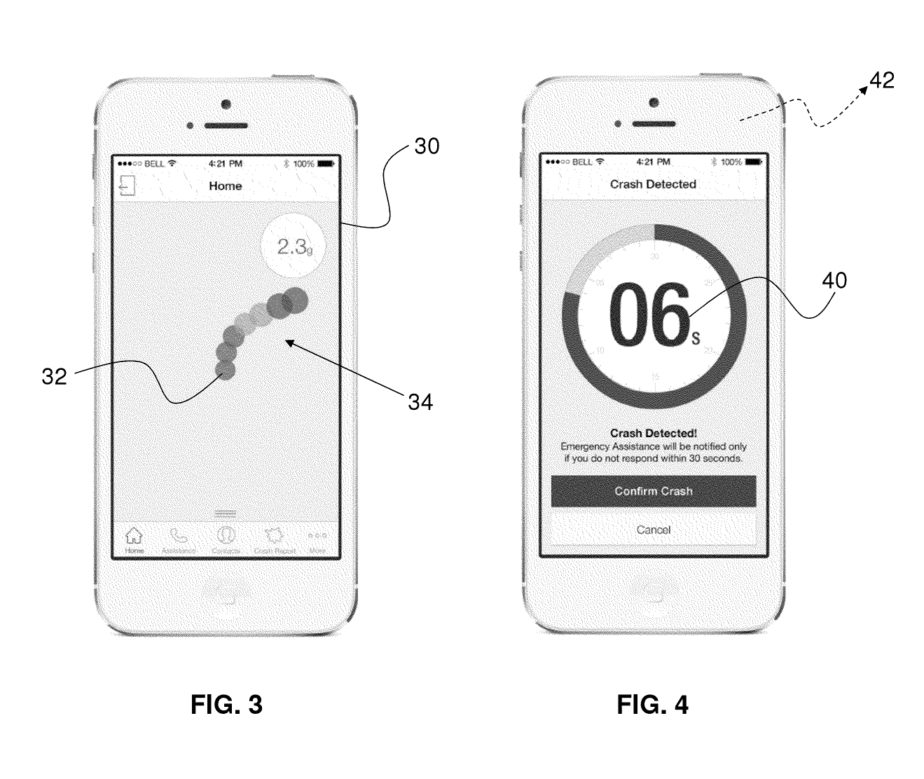

To translate the information collected from sensors of a smartphone into a meaningful experience, in the embodiment where the application 30 is observable by the user, depicted in FIG. 3, the system employs a visual sphere 32 displayed on the user's screen. This sphere 32 moves 34 in coordination with live data obtained from the phone's accelerometer. The sphere 32 tracks acceleration in the x-axis (left to right side of the phone), the y-axis (top of screen to bottom of screen), and the z-axis (from the screen surface to the back surface of the phone). While x and y positions are easily shown in the two dimensional surface of the phone, the z axis in this exemplary embodiment is depicted by changing the size of the sphere, which gives the user a perspective of the sphere moving toward and away from the viewer in a three-dimensional space. The application, as depicted in FIG. 3, may be observable to a user in the “foreground” or operate in the “background” (i.e., operational but not visible) or operate in an application that the user has quit but is still functional.

Accident detection is performed as a Bayesian inference algorithm incorporating the motion signature acquired from the accelerometer and gyroscope (when available) as well as the vehicle's speed and heading from the available location services. The location data for a mobile phone may be determined using a variety of methods including, for example, GPS, assisted GPS (network triangulation and GPS), WIFI location, geo-located user determined location, Cell ID, and others. Some of the above location-determining technologies can be done on the network, some are done on the mobile device, and some are a combination of both. There is often a trade-off between quality of location and the power required to determine location. To preserve device battery power, the systems and methods select the lowest power location option when necessary. For instance, software is programmed to know when the device is connected to a power source and, thus, a more accurate location technology may be utilized without draining the battery. Additional sensors both from the mobile device and from devices paired to the mobile device can be used to determine context, providing for additional inputs into the accident detection algorithm to increase the confidence interval of detection and provide situational context. Such sensors may include those mentioned above and an altimeter, barometer, magnetometer, compass, ambient light sensor, heart rate or pulse sensor, infrared (IR) sensor, cameras (front and rear facing), flash (any light emitting function that can be used in combination with cameras or ambient light sensor), and microphone (potentially used in combination with speakers).

To minimize on-board data requirements, the device may record for a specified duration before and after an accident event (e.g., twenty seconds in total, ten seconds before and ten seconds after), using a first-in-first-out method to save only data pertinent to the experienced impact. This will provide data of the context immediately prior to, during, and after the accident. For example, recording vehicle motion prior to and after the accident could help emergency services understand potential injury severity from secondary impacts. The ACM application can function like a digital video recorder (DVR) or store data in the cloud.

While all new vehicles after the year 2015 will be mandated to have an event data recorder (EDR) or “black box” to record data pertinent to accidents, access and use of this data is complicated and generally requires expertise that makes it cost prohibitive to use in most insurance accident claims processing. The present ACM system takes advantage of the mobile accident detection logic to record motion signature location and motion data elements immediately before and after a detected event using a first in first out method of data storage to the mobile device. The present ACM system maintains the integrity of the relevant data to provide context around the accident while minimizing impact to mobile device usability. The data is then used to aid in the claims process post-accident and shorten the claim cycle improving the experience for the insured and reducing related claims expense for the insurer. The data elements acquired through various sensors and derivative metrics thereof could include: vehicle speed pre and post event, delta-v experienced during crash, crash pulse or duration, follow on impacts with additional metrics (secondary and tertiary collisions—e.g. rollovers or multiple vehicle events), ambient volume of the vehicle (e.g. music volume). When the application is used by multiple occupants within the same vehicle, the combined data elements collected during an event from all involved mobile devices and paired devices (e.g. health trackers, watches, visual aids like Google Glasses) are used to further increase the confidence interval of the detection algorithm while also providing significantly better context around detected events. When multiple devices are used the sensor data outputs and derived metrics are then provided as inputs to the ACM system to potentially request multiple ambulances in the event of a severe multi-occupant accident. When one or more users is able to interact with the contact center specialists this also provides inputs to customize the coaching provided to the accident victims to properly triage and potentially provide first aid while awaiting emergency services.

A mobile ACM application that detects a suspected crash will be aware of wearable computing devices that are within the vehicle at the time of the crash. At registration the wearable devices may be synced with a mobile device, connect directly to cellular network, and/or connect to the vehicle WIFI/embedded connected vehicle technology. At trip start the master ACM solution, the lead device in the vehicle with primary connection to the server, will confirm which registered wearable computing devices are present, and the location of each wearable computing device in the vehicle. The ACM system may measure biometric information during the drive, to determine if the user is a driver or passenger. The ACM system can also determine if the user is or awake or asleep. In addition, the ACM system can determine whether the user is in the front or rear of the vehicle. Communicating via Bluetooth, near field communication (NFC), or another local area network (LAN) or personal area network (PAN), the ACM upon receiving an indication that an accident may have occurred will consult wearable computing device biometric data to confirm a crash. In one embodiment, the ACM system uses biometric data, for example, sensing higher heart beat rates. This additional data can be used to increase confidence of a crash and engage emergency protocols quicker. In addition at the time of a severe accident the ACM application may communicate the health of the passengers of a vehicle to a contact center and emergency medical services (EMS).

For insurance first notice of loss (FNOL) purposes, the biometric data from the wearable computing device may be used to confirm severity of personal injuries to enable faster resolution of claims.

In one embodiment, the ACM application uses combinatory analysis to provide further information regarding an event. The ACM application collects data from multiple devices involved in the same event to provide a more granular event data record, more accurate emergency services dispatching (e.g., one ambulance or three ambulances), and an accident report documenting the individuals involved.

When the ACM system suspects a crash, the ACM system confirms the crash using data from the mobile and/or the wearable device. Sensors relevant for ACM include, but are not limited to global positioning system (GPS), assisted GPS (AGPS), network GPS, triangulation, velocity, gyroscope, altimeter, barometer, accelerometer, magnetometer, compass, infrared (IR), movement (e.g., using the accelerometer to determine if a user is sleeping), microphone, speaker, heart rate, pulse, light/strobe/flashlight technology using a camera function of a mobile device, a still photograph function of the mobile device, a video function of the mobile device, ambient light (to detect the orientation of the phone). In one embodiment, a pulse can be measured using an IR sensor.

In one embodiment, the ambient light sensor is used to determine the relative position of the mobile device. The ambient sensor senses lightness or darkness. For example, if the ambient sensor determines that light is present on a front camera lens of the mobile device, a determination can be made that the device is some orientation other than face down. If the ambient light sensor senses darkness on a front camera lens of the mobile device, a determination can be made that the device is face down. The ambient light sensor can be used for both a front lens and a back lens of a mobile device to determine the orientation of the mobile device when there is a front and back camera on a mobile device. The ambient light sensor can be useful in determining what happens between an orientation before an accident and the orientation of the mobile device after an accident. In one embodiment, a flash function of the mobile device can be used to take pictures and/or record video prior to, during, and after an accident. In one embodiment, the flash function is a light emitting diode (LED) flash.

The method uses the Bayesian inference algorithm to identify the impacts experienced by the phone and/or wearable device and which impacts have a high probability of indicating a motor vehicle accident. This process eliminates false positives—circumstances in which a phone is dropped when not in a vehicle, when the phone is dropped when in a vehicle, and when moved in such a way that the phone registers significant velocity changes. This process likewise eliminates false negatives, where the device does experience a significant impact, yet the signal input is detected as noise instead of registering as an auto accident.

Sensor data is acquired to build the motion signature of the user. Over time, accident motion signatures are captured. An analysis of motion signature patterns, through machine learning techniques, such that a detection confidence interval increases and a severity threshold of event detection decreases, allow for low severity crashes to be correctly detected. The severity of a detected event determines the response from the ACM platform, a contact center specialist, and the user input expected by the application user interface, e.g., to engage in self-service management of the detected event. Using ACM, accidents can be managed with an appropriate level of response to the severity of the event. In accidents where the driver may be incapacitated, emergency services can be engaged immediately. In lower severity events, the contact center response can attempt to reach out to the user, e.g., by contacting the user on the user's mobile device, before attempting emergency services dispatching. The data of the event in all cases is logged immediately with follow on action from the ACM system/platform, contact center, and users as appropriate.

The output of this Bayesian inference algorithm is a motion signature used to determine when the user is driving or riding in a vehicle, or is on foot. This method identifies motion types to minimize impact on the battery by not using the device's radios during motion types not consistent with vehicle travel.

The driver of the vehicle can also be determined by other methods. In one embodiment, memory settings in the vehicle can be used by the ACM system to determine whether the user is the driver of the vehicle. In one embodiment, the ACM system can determine the driver of the device by determining what user's device is paired with a head unit of the vehicle. In one embodiment, a proximity sensor in the vehicle can be used by the ACM system to determine the driver of the vehicle.

Once a vehicle accident is detected, the application 30 produces a data call and, as shown in FIG. 4, the user has a specific period of time 40 within which to cancel this call request. If not canceled by the user, the application then passes 42 the user's location, the user id, the severity, and the impact direction to a non-illustrated contact center (e.g., a physical system or an application or a combination of both) to manage an emergency response. The contact center application then manages dispatch of relevant and proper emergency services based on the user's location. This process overcomes the challenges commonly experienced with 911 and mobile devices, whereby a user is connected to the public safety answering point associated with a cell phone tower and not necessarily the user's actual location. In this manner, the user, regardless of his/her ability to employ or engage with the device and regardless of the level of technology within the vehicle, is protected and is provided with a fast, potentially life-saving emergency response.

Motion signature as referenced herein builds on a prior application that identifies method of travel based upon geolocation. By using this motion signature, the application can significantly improve battery performance and response.

As the industry moves to Next Generation 911, the systems and methods described herein aid in providing emergency services advanced information of the severity of an impact and significantly increase the speed of an emergency response.

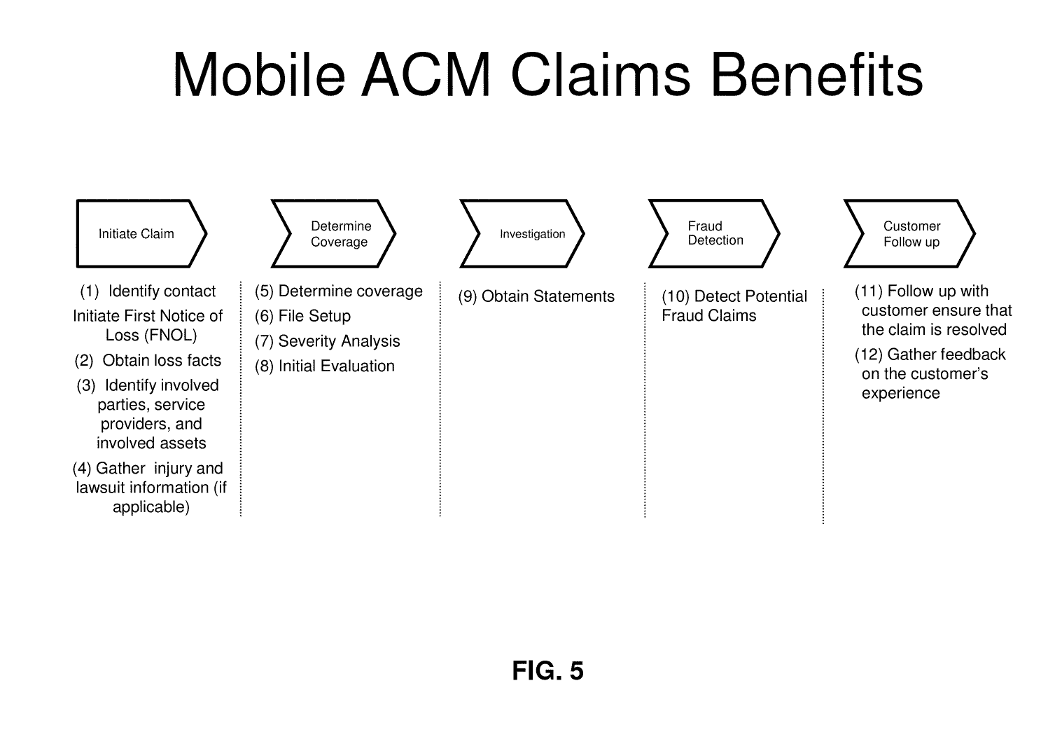

Following an accident, the user can choose to provide the data recorded pre- and post-accident to an insurance provider to aid in the determination of fault and claim resolution. Thereby removing days from the typical claims cycle time, minimizing fraud, and improving customer satisfaction with the claims process. In this regard, FIG. 5 illustrates benefits provided by the instant systems and methods when used in conjunction with insurance claims. First, the ACM can initiate the claim automatically. In this regard, the application identifies the contact person and initiates the first notice of loss. Some loss facts are obtained automatically and a prompt can be made to identify the parties and assets involved and can recommend service providers. Injury and lawsuit information can be gathered if applicable. This automatic process can, therefore, start the process for determining coverage by setting up the file, analyzing the severity, and initiating the accident evaluation process, which includes scheduling the investigation for obtaining statements from relevant witnesses. By including actual accelerometer data, the process can be used to detect fraud by comparing actual measured variables with what the claimant is reporting. Finally, the process can schedule, automatically, follow up with the insured to make sure that the claim is resolved and also gather feedback from the insured on the experience regarding the claims process.

As stated above, the ACM can initiate a claim automatically. A confirmed accident following an ACM notification may be used to automatically set up a case file on the insurer's customer relationship management (CRM) system. The time, location, severity, wearable biometrics, accident photographs, service provider accident scene management (ASM) report and other EDR data may be logged and recorded under the case file. The mobile or mobile application may then become the primary communication channel to quickly bring the claim to resolution.

In one embodiment, with respect to ACM, agent scripting can be customizable based on the severity of an accident as determined by the ACM system. The language that agents use can be customizable, e.g., linking specialized scripting to the severity of an accident. Biometric data collected from one or more sensors in the mobile device and/or in the wearable computing device can indicate to appropriate third parties that one passenger needs special medical attention. An agent, e.g., using customized scripting can advise a driver or passenger of first aid requirements before EMS arrives.

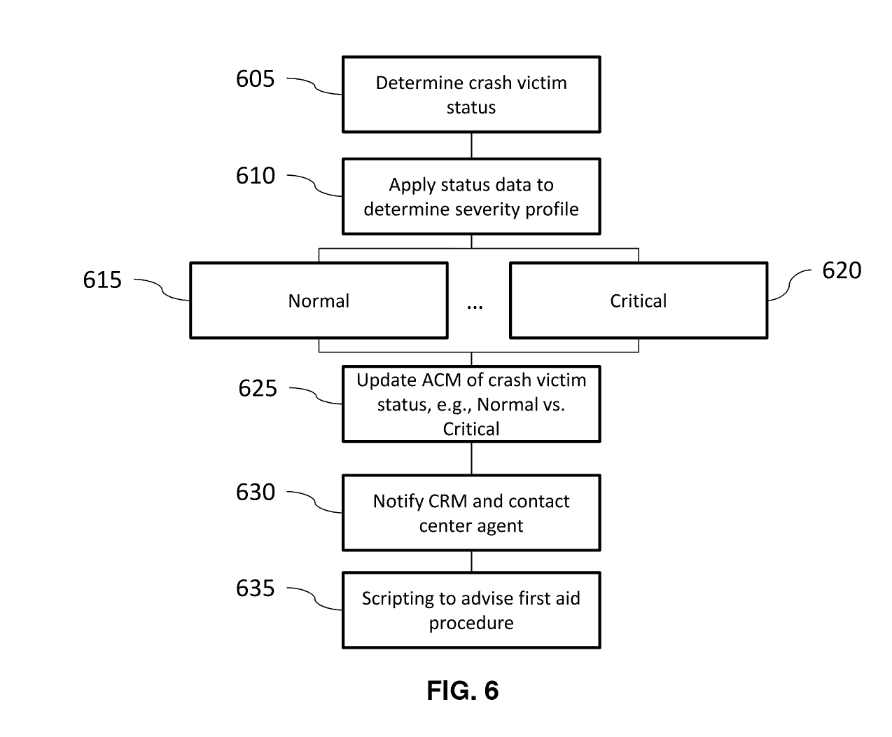

FIG. 6 illustrates a block diagram of a method for determining a severity of an accident according to one embodiment. In block 605, the ACM system determines a status of one or more accident victims. The status can be determined from the one or more available sensors from which sensor data is available, e.g., from the mobile device and/or wearable computing device. In one embodiment, biometric information is available, e.g., from a wearable computing device, to determine the status of the accident victim(s). At block 610, the status data is applied to determine the severity of an accident from a plurality of status profiles. Although FIG. 6 shows only severity profiles indicating a “normal” 615 or “critical” 620 status, the present ACM system can be applied using more than two profiles. At block 625, the mobile device updates the ACM system, e.g., at the off-board server, of the status of the accident victim. At block 630, the CRM system and contact center agent are notified. At block 635, customized scripting is provided by the contact center agent to advise of any applicable first aid procedures based on the determined severity of the accident.

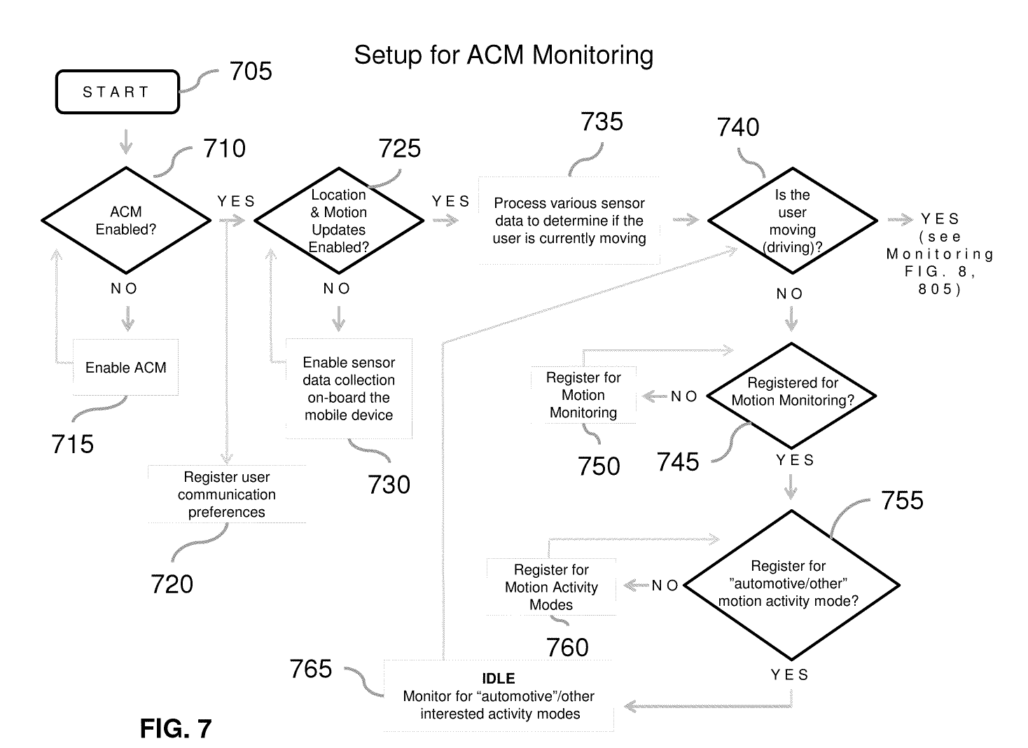

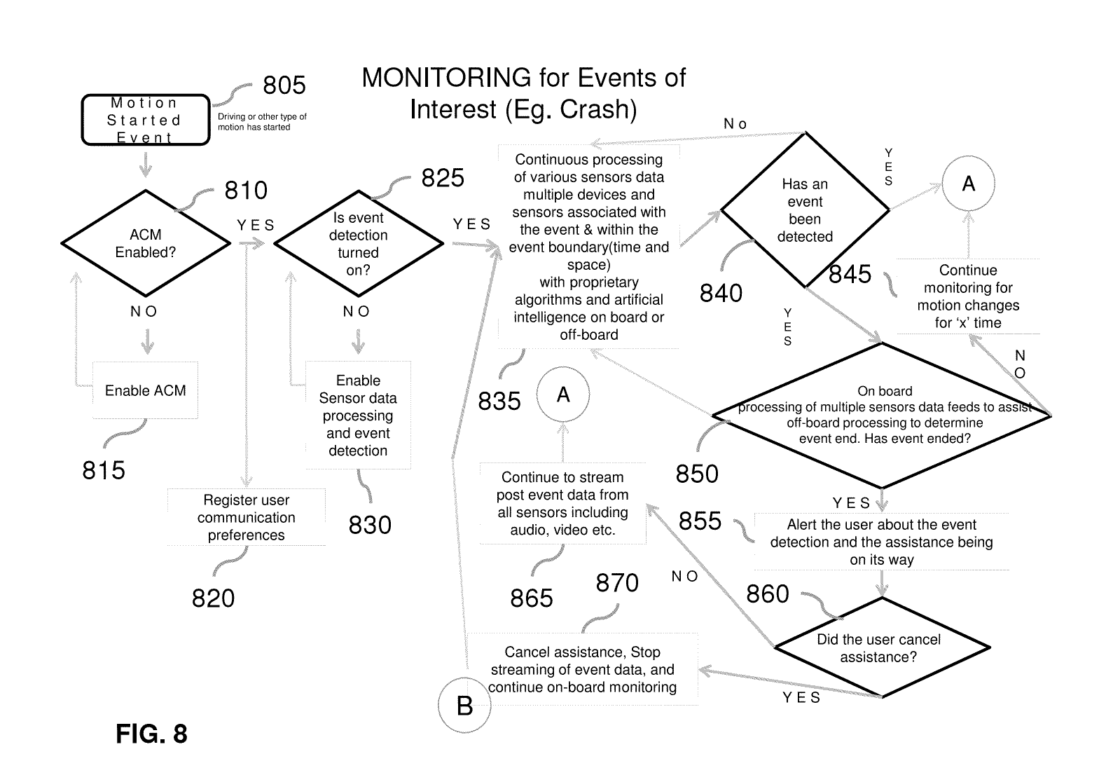

FIG. 7 illustrates a block diagram of a method for setting up ACM monitoring according to one embodiment. The method begins at block 705. At block 710, a determination is made as to whether ACM is enabled on the mobile device. If ACM has not been enabled, it is enabled at block 715. Once ACM is enabled, user communication preferences can be registered at block 720 and a determination is made as to whether location and motion updates are enabled at block 725. If location and motion updates have not been enabled, they are enabled at block 730. Once location and motion updates are enabled, various sensor data is processed to determine whether the user is currently moving at block 735. A determination as to whether the user is moving, e.g., driving, is made at block 740. When the user has been determined by the ACM system to be moving, the method proceeds to block 805 of FIG. 8 where monitoring is initiated. If the system determines that the user is not moving, a determination is made as to whether the user is registered for motion monitoring at block 745. If it is determined that the user is not registered for motion monitoring, this occurs at block 750. Once the user is registered for motion monitoring, a determination is made as to whether the user is registered for an “automotive/other” motion activity mode in block 755. If it is determined that the user is not registered for the “automotive/other” motion activity mode, this occurs at block 760. Once the user is registered for the “automotive/other” motion activity mode, the ACM application of the mobile device remains idle while monitoring for automotive or other interested activity modes, e.g., boating, skiing, flying, etc., at block 765. From block 765, the system proceeds to block 740 to determine whether the user is moving.

FIG. 8 illustrates a block diagram of a method for monitoring events of interest according to one embodiment. At block 805, a motion event, e.g., driving or other type of motion, has started. At block 810, a determination is made as to whether ACM is enabled on the mobile device. If ACM has not been enabled, it is enabled at block 815. Once ACM is enabled, user communication preferences can be registered at block 820 and a determination is made as to whether event detection is turned on, e.g., enabled, at block 825. If event detection has not been enabled, sensor data processing and event detection is enabled at block 830. Once event detection has been turned on, processing of data from various sensors occurs at block 835. The sensor data can be from multiple devices and sensors that are associated with the event and fall within the event boundary (time and space). The processing of sensor data is provided using proprietary algorithms and artificial intelligence either on board (e.g., on the mobile device) or off-board. The processing of sensor data can be periodic or continuous, e.g., in real-time depending on the resources available to the mobile device. When the sensor data is processed periodically or in real-time, this data can be processed per millisecond, microsecond, nanosecond, picosecond, femtosecond, etc.

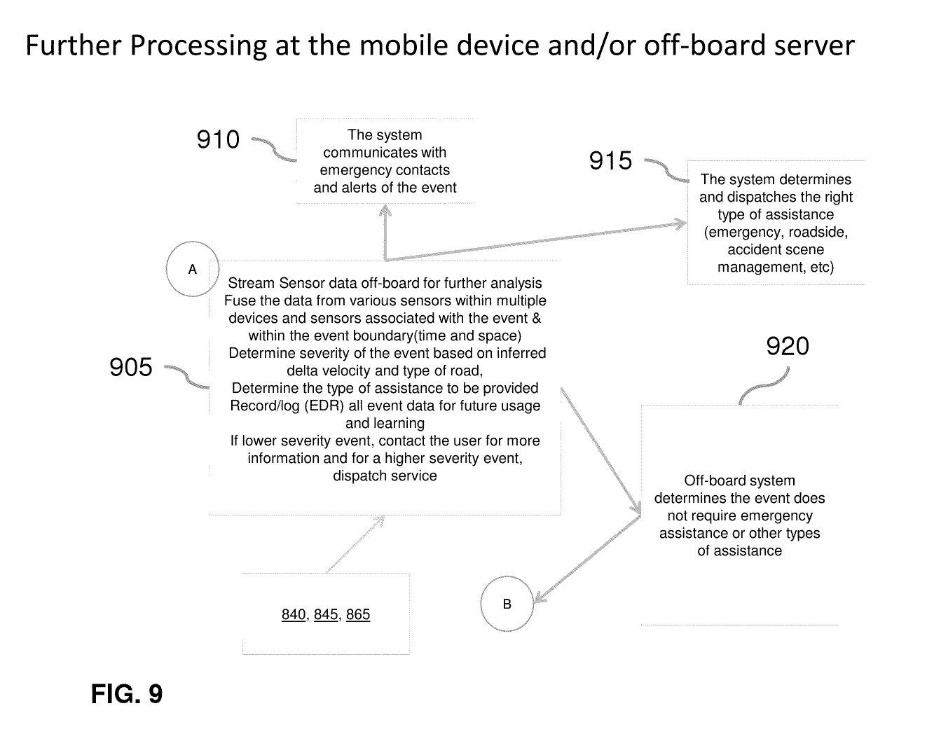

At block 840, a determination is made as to whether an event has been detected. If an event has not been detected, continuous processing of sensor data continues at block 835. Once an event has been detected, the method automatically proceeds to block 905 of FIG. 9 for further processing, which can be done with the ACM application either on the mobile device, on the off-board server, or both. Further processing will be described in further detail below. In parallel, the method also proceeds to block 850 where a determination is made as to whether an event has ended. Processing of multiple sensor data feeds occurs on board to assist in off-board processing of the determination of the end of an event. If the event has not been determined to have ended, motion changes are monitored for a predetermined amount of time at block 845 before proceeding to block 905 for off-board processing. Once a determination has been made that the event has ended, the method either proceeds back to block 835 (for continued sensor analysis, which increases confidence of an event until a threshold is reached) or proceeds to block 855. At block 855, the user is alerted that an event has been detected and that assistance is forthcoming.

The user has the option to cancel assistance at block 860. If the user does not cancel assistance, post event data continues to be streamed from all sensors, e.g., audio, video, or other sensor data at block 865. The method then proceeds to block 905.

If the user cancels assistance, event data streaming is stopped at block 870. On-board monitoring of sensor data is continued at block 835.

Upon detecting an event, for example, at block 840, the application on the mobile device initiates the data stream and continues to determine severity and monitor for other events at block 905. In parallel, the back end, e.g., the off-board server, does a similar severity determination along with additional sensor data as it becomes available.

FIG. 9 illustrates a block diagram of a method for providing off-board processing of an event according to one embodiment. At block 905, sensor data is streamed off-board for further analysis. Data from various sensors is combined. This sensor data can be from multiple devices. The sensor data is associated with the detected event and within the event boundary (space and time). A severity of the event can be determined, e.g., using the method of FIG. 6. In one embodiment, the severity of the event can be based on an inferred delta velocity and the type of road. The items described in element 905 can be performed with the ACM application on the mobile device and/or on an off-board server. In one embodiment, sensor data is streamed off-board independent of any severity analysis performed by the ACM application. As stated above, with respect to FIG. 6, the severity of the event can also include biometric data of one or more users and/or other relevant sensor data to determine a severity. Once the severity has been determined, the type of assistance to be provided can be determined. In one embodiment, all event data is recorded/logged (e.g., using electronic data recording (EDR) methods). This EDR data can be collected for future usage and/or learning. In one embodiment, for a lower severity event, the user can be contacted for more information. In one embodiment, for a higher severity event, service, e.g., EMS, is dispatched. In one embodiment, at block 910, the system communicates with emergency contacts and alerts the emergency contacts of the event. In another embodiment, at block 915, the system determines and dispatches the right type of assistance, e.g., emergency, roadside, accident scene management, etc. In yet another embodiment, at block 920, the off-board system determines that the event does not require emergency assistance or any other type of assistance and returns to element 870 of FIG. 8 where assistance is canceled and streaming of event data is stopped.

In one embodiment, retrospective ACM EDR can be provided. In certain circumstances, an event occurs that may be below the threshold for mobile ACM. For example, a minor collision, e.g., hitting a wing mirror, a low velocity bumper to bumper event, or hitting road kill. The ACM application can act as a mobile event data recorder that can be used to retrospectively record event information, e.g., for minor events. The retrospectively recorded event information can be stored on the mobile device and/or off-board, e.g., in the cloud.

Minor events follow a predictable path dependency:
(1) An event profile recorded by the sensors, GPS, and/or accelerometer;
(2) A deceleration;
(3) Parking on the side of the road;
(4) Device and vehicle remain on side of the road for a short duration while damage is examined/and insurance details are shared with a third party (if applicable);
(5) A phone call may be made to an insurance company or other contact;
(6) A camera may record details of the event;
(7) The user continues the drive to a destination.
   Traffic information at geographical location may also indicate a partial blockage on the road, post event, as further evidence of a minor event.

In time through machine learning and probabilistic inference a retrospective ACN/EDR engine determines with increased accuracy the profiles of minor accidents from recordings of the sensor data. Such information may be used to further supplement claims and underwriting information at insurance companies.

Mobile ACM can Help Drive Customer Satisfaction. For example, it can demonstrate empathy with the policy holder's misfortune. It reduces the time required from the insured in reporting first notice of loss (FNOL) through a phone call. It provides an opportunity to put the claimant at ease by already having performed the reporting and proactively can explain the claims process and answer any questions the insured may have. Finally, it can ensure that the policy holder is informed with and knows the correct channel for submitting questions related to the claim.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The phrase “at least one of A and B” is used herein and/or in the following claims, where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for providing automatic crash management (ACM), which comprises:
enabling an ACM application on a mobile device;
collecting data from a plurality of sensors associated with the mobile device;
processing the data from the plurality of sensors with the ACM application;
monitoring the processed data with accident detection logic of the ACM application running on the mobile device to determine whether a crash has been detected;
determining a severity of the crash from the processed data with the ACM application;
sending the determined severity to an off-board server; and
automatically streaming the data from the plurality of sensors to the off-board server for further analysis upon detection of the crash.

2. The method of claim 1, wherein the plurality of sensors are located in the mobile device.

3. The method of claim 2, wherein the plurality of sensors are located in one or more wearable computing devices in addition to the sensors located in the mobile device.

4. The method of claim 3, wherein the wearable computing devices are synced with the mobile device.

5. The method of claim 3, wherein the wearable devices connect with a cellular and/or WIFI network.

6. The method of claim 3, wherein the ACM application confirms the crash using data from the plurality of sensors of the mobile device and/or wearable computing device.

7. The method of claim 1, wherein crash detection is performed as a Bayesian inference algorithm incorporating a motion signature of the mobile device.

8. The method of claim 1, wherein the processed data is recorded for a specified time before and after a detected crash.

9. The method of claim 1, wherein an ambient light sensor of the mobile device is used by the ACM application to determine a relative position of the mobile device.

10. The method of claim 1, wherein a flash function of the mobile device is used by the ACM application to take pictures and/or record video prior to, during, and after the crash.

11. The method of claim 1, wherein the ACM application determines status data of a crash victim with the plurality of sensors.

12. The method of claim 11, wherein the status data includes biometric information.

13. The method of claim 1, wherein the severity of the crash is based on an inferred delta velocity and a road type.

14. The method of claim 1, wherein biometric data in addition to other sensor data of the plurality of sensors is used to determine severity.

15. The method of claim 1, wherein the ACM application alerts a user of the mobile device that a crash has been detected.

16. The method of claim 15, wherein the ACM application provides a user of the mobile device with an option to cancel assistance.

17. The method of claim 1, wherein the ACM application initiates the automatic streaming of the data from the plurality of sensors and continues to determine severity and monitor for other events with the mobile device.

18. The method of claim 1, wherein the ACM application acts as a mobile event data recorder that retrospectively records event information.

19. The method of claim 1, wherein the data from the plurality of sensors is processed one of periodically and continuously depending on the resources available to the mobile device.

20. A method for providing automatic crash management (ACM), which comprises:
enabling an ACM application on a mobile device;
collecting data from a plurality of sensors associated with the mobile device;
periodically processing the data from the plurality of sensors with the ACM application;
monitoring the processed data with accident detection logic of the ACM application running on the mobile device to determine whether a crash has been detected; and
automatically streaming the data from the plurality of sensors to the off-board server for further analysis upon detection of the crash.
